(19) United States
(12) Patent Application Publication
(10) Pub. No.: US 2003/0107364 A1
(43) Pub. Date: Jun. 12, 2003

(54) Magnetically encapsulated coil package for variable reluctance sensors

(76) Inventor: Jose Antonio Galvan, Chihuahua (MX)

Correspondence Address: MAGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 10/011,104

(22) Filed: Dec. 7, 2001

(51) Int. Cl. G01P 3/48; G01P 3/54

(52) U.S. Cl. 324/174

(57) ABSTRACT

A magnetically encapsulated coil package of a variable reluctance sensor, wherein the magnetic encapsulation distributes the magnetic flux such as to permit the coil winding to be axially elongated with respect to the magnet, yet the signal output therefrom is suitably large. The variable reluctance sensor includes an annular magnet having alternating di-poles; a toothed wheel having an annular toothed portion, wherein the toothed portion is disposed proximally to, and concentrically inside, the magnet; and an encapsulated coil package which includes an annular coil disposed in axially offset relation to the annular toothed portion and the annular magnet; and a magnetically conductive capsule having an inverted U-shaped cross-section which serves as a return path for magnetic flux of the magnet and constrains magnetic activity to the interior space thereof.

### TECHNICAL FIELD

The present invention relates to variable reluctance sensors of the type for example used as an automotive wheel bearing speed sensor, and more particularly to a variable reluctance sensor having a magnetically encapsulated coil package for improved magnetics.

### BACKGROUND OF THE INVENTION

Variable reluctance sensors are used in automotive applications at, for example wheel bearings, to sense wheel rotation. The generated wheel rotation information is then utilized by the vehicle computer control systems, as for example a control system involved with an anti-lock brake system (ABS).

FIG. 2 depicts a prior art variable reluctance sensor 10 mounted to a wheel bearing (see for example wheel bearing 104 at FIG. 1). The sensor 10 includes an annular magnet 14 having circumferentially disposed, serially alternating di-poles, preferably for example 94 di-poles. A toothed wheel 16 has a circumferentially disposed annular toothed portion 16a having teeth 18 and slots 20, preferably for example having 47 teeth and 47 slots. The toothed portion is disposed proximally to, and concentrically inside, the annular magnet 14. An annular coil 22 is disposed in axially offset relation to the annular toothed portion 16 and the annular magnet 14. A metal housing component 24 conjoins a plastic housing component 26 so as to collectively form a housing 28 which encloses the variable reluctance sensor 10. An electrical connector 30 is located on the housing 28 which provides an output from the coil 22. The coil is configured so that the winding of the coil is axially compacted as close as possible to the magnet 14 in order that a suitable voltage output is produced thereby at the connector 30 as the toothed wheel rotates relative to the magnet. In this regard, by way of example, the toothed wheel is connected to a rotor and the housing, coil, magnet and connector are mounted to a stator, wherein the rotor rotates with a wheel and the stator is stationary in relation to the an axle of the motor vehicle.

What remains needed in the art is an improved magnetic circuit for a variable reluctance sensor, wherein the coil may have an axially elongated configuration, rather than a conventional axially compact configuration, with respect to the magnet.

### SUMMARY OF THE INVENTION

The present invention is a magnetically encapsulated coil package of a variable reluctance sensor, wherein the magnetic encapsulation distributes the magnetic flux such as to permit the coil winding to be axially elongated with respect to the magnet, yet the signal output therefrom is suitably large.

The variable reluctance sensor includes an annular magnet having alternating di-poles; a toothed wheel having an annular toothed portion, wherein the toothed portion is disposed proximally to, and concentrically inside, the magnet; and an encapsulated coil package which includes an annular coil disposed in axially offset relation to the annular toothed portion and the annular magnet; and a magnetic capsule having an inverted U-shaped cross-section which serves to magnetically encapsulate the coil. The magnetic capsule has an axially disposed outboard component which extends to adjacency with the magnet, an axially disposed inboard component which extends to adjacency with the toothed wheel, and a radially disposed connector component which integrally adjoins the inboard and outboard components at a location distal from the magnet.

The magnetic capsule is composed of a magnetically conductive material, for example a ferromagnetic material such as steel, having a low reluctance which serves as a return path for magnetic flux of the magnet and constrains magnetic activity to the interior space thereof. As a result, magnetic flux is caused to pass through the coil, even where the coil is axially elongated, and yet an acceptable level of output signal (as compared with conventional variable reluctance sensors) will be generated by the coil.

Accordingly, it is an object of the present invention to provide a magnetically encapsulated coil package for a variable reluctance sensor which optimizes the magnetic circuit and thereby permits utilization of axially elongated coils.

This and additional objects, features and advantages of the present invention will become clearer from the following specification of a preferred embodiment.

### BRIEF DESCRIPTION OF THE DRAWINGS

FIG. 1 is a perspective view of a variable reluctance sensor mounted to a wheel bearing.

FIG. 2 is a cross-sectional schematic side view of a prior art variable reluctance sensor.

FIG. 3 is a cross-sectional schematic side view of a variable reluctance sensor having a magnetically encapsulated coil package according to the present invention.

FIG. 4 is a sectional view, seen along line 4-4 of FIG. 3.

FIG. 5 is a sectional view, seen along line 5-5 of FIG. 5.

FIG. 6 is a cross-sectional schematic side view of a portion of the variable reluctance sensor equipped with the magnetically encapsulated coil package according to the present invention, showing flux line paths.

FIG. 7 is a cross-sectional side view of a most preferred embodiment of a variable reluctance sensor having a magnetically encapsulated coil package according to the present invention.

FIGS. 8A through 8D depict perspective views of assembly of the variable reluctance sensor having a magnetically encapsulated coil package of FIG. 7.

### DESCRIPTION OF THE PREFERRED EMBODIMENT

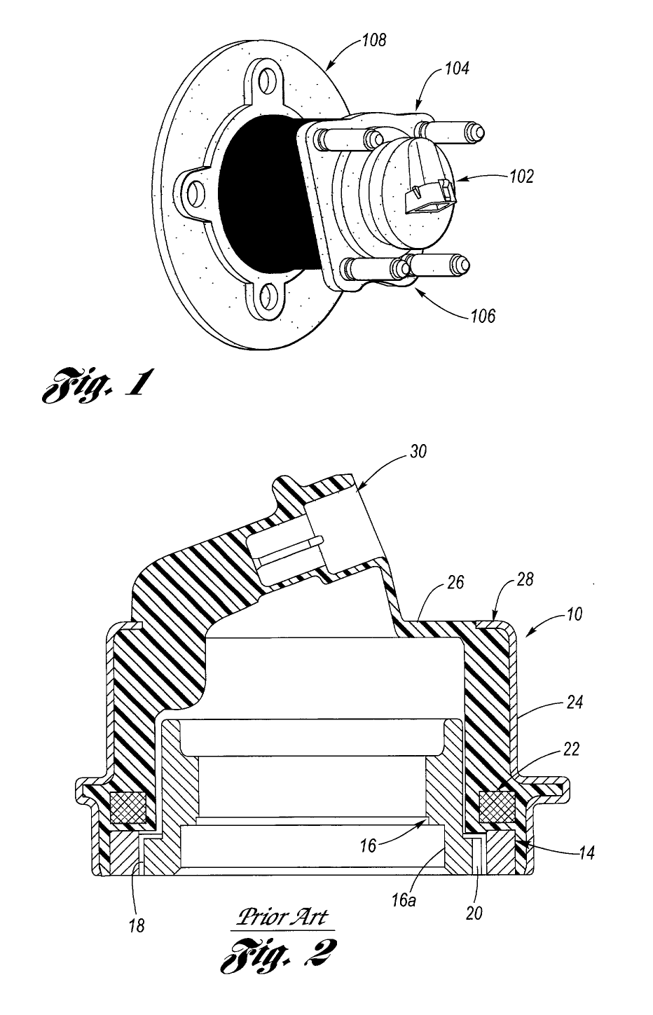

Referring now to the Drawing, FIGS. 1 and 3 through 8D depict an example of a magnetically encapsulated coil package 100 utilized as a component of a variable reluctance sensor 102. The variable reluctance sensor 102 may be used for any purpose, as for example mounted to an automotive wheel bearing 104 for sensing wheel rotation, wherein an electrical signal is provided which is indicative of wheel rotation speed and is utilized, for example, by an ABS control module. As shown at FIG. 1 by way of example, the wheel bearing 104 includes a stationary stator 106 which is connected to an axle of a motor vehicle and a rotor 108 which is rotatable in relation to the stator and is connected to a wheel of the motor vehicle.

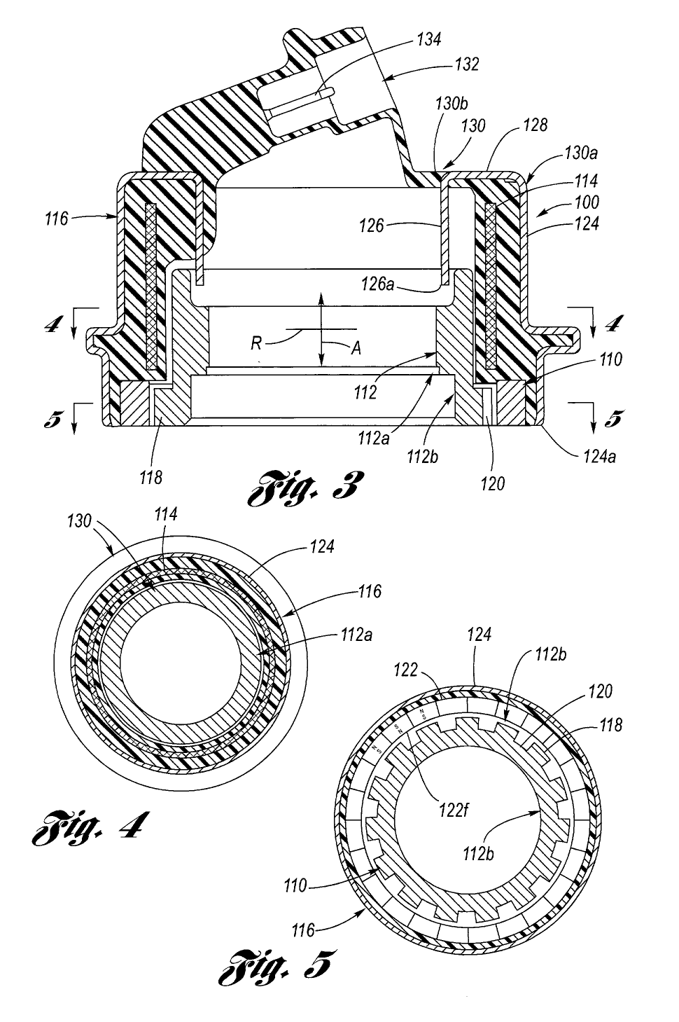

As depicted at FIGS. 3 and 7, the variable reluctance sensor 102 includes an annular magnet 110; a toothed wheel 112; and the encapsulated coil package 100 which includes an annular coil 114 disposed adjacent the annular magnet; and a magnetic capsule 116 having an inverted U-shaped cross-section which serves to magnetically encapsulate the coil. The toothed wheel 112 and the annular magnet 110 are of conventional configuration as discussed hereinabove with regard to FIG. 2.

The toothed wheel 112 has a central portion 112a and a toothed portion 112b. The toothed portion 112b has a series of teeth 118 and slots 120 (see also FIG. 5). Preferably, but not necessarily, the number of teeth is 47 and the number of slots is also 47. The toothed wheel is composed of a ferromagnetic material, as for example powder metal, and is, for example, connected to the aforementioned rotor.

The annular magnet 110 has a number of serially alternating dipoles 122 disposed on its circumference, as best depicted at FIG. 5. Preferably, but not necessarily, the number of di-poles is 94 (ie., twice the number of teeth/slots). Each of the di-poles 122 is arranged radially (that is parallel to the plane R) so as to provide a pole face 122f which faces toward, is concentrially aligned with, and is adjacent to, the teeth and slots of the toothed portion 112b. The annular magnet 110 is, for example, mounted to the stator, wherein as the toothed wheel rotates relative to the annular magnet, pulsations in the magnetic field therebetween occurs.

The coil 114 of the magnetically encapsulated coil package 100 is annular and composed of a plurality of turns of an electrical conductor, such as copper. One end of the coil is located adjacent to, and axially (ie., parallel the axis A) offset with respect to, the annular magnet 110 and toothed portion 112b. In a preferred configuration of the coil 114, the coil is axially elongated, as shown generally at FIG. 3, in contradistinction to a conventional axially compact configuration, as depicted generally at FIG. 2.

The magnetic capsule 116 magnetic capsule 100 has an axially disposed outboard component 1124, an axially disposed inboard component 126 and a radially disposed connector component 128. The outboard component has an end 124a which is in adjacency with the annular magnet 110. The connector component 128 is integral with the outboard component 124 opposite the end 124a, collectively forming a first housing element 130a of a sensor housing 130. The inboard component 126 is integrally connected to the connector component 128 opposite the outboard component 124, wherein the inboard component is concentric relative to the outboard component. The inboard component 126 has an end 126a which is in adjacency with the toothed wheel 112 at the central portion 112a.

Connected with the first housing element 130a of the housing 130 is a second housing element 130b, preferably composed of plastic. An electrical connector 132 is integrated with the housing 130, having electrodes 134 which are connected to the coil 114. The housing 130 and the magnetically encapsulated coil package 100 are, for example, mounted to the aforementioned stator.

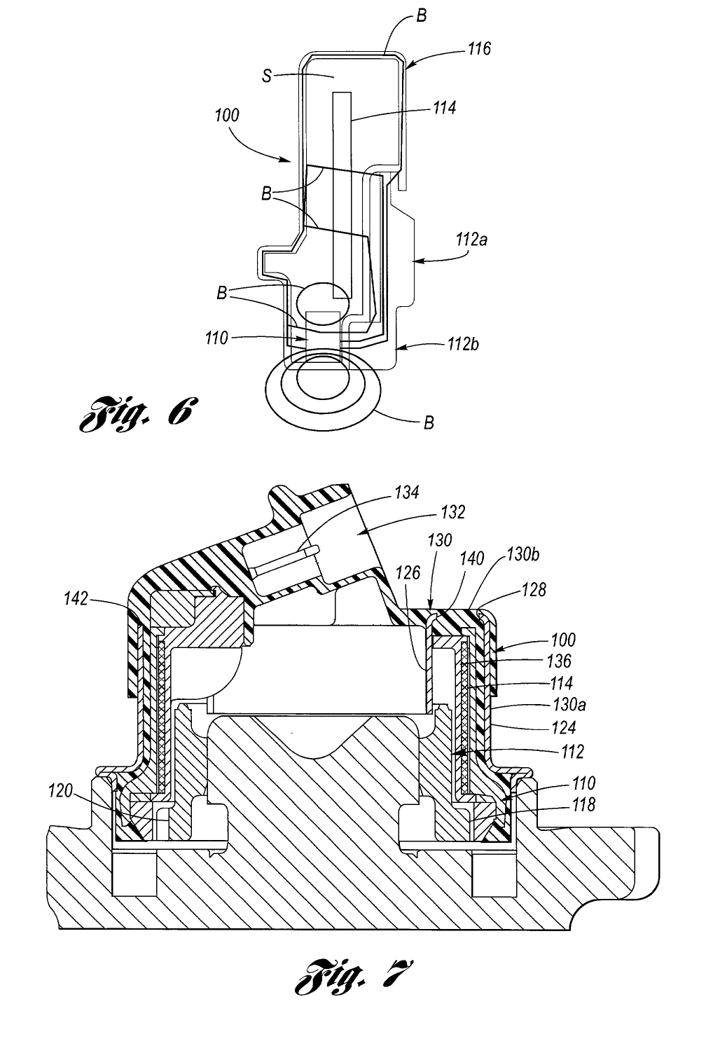

The magnetically encapsulated coil package 100 has the advantage that the magnetic circuit (constituted by the annular magnet 110, the toothed wheel 112, the coil 114, the magnetic capsule 116 and the air space S therewithin) is optimized by the presence of the magnetic capsule 116, as schematically depicted at FIG. 6. The magnetic capsule 116 is composed of a magnetically conductive material, for example a ferromagnetic material such as steel, having a low reluctance which serves as a return path for magnetic flux B of the magnet 110 and constrains magnetic activity to the interior space S thereof. As a result, magnetic flux is caused to pass through the coil 114, even though the coil is axially elongated, and yet an acceptable level of output signal (as compared with conventional variable reluctance sensors) will be generated by the coil. In this regard, as the toothed wheel 112 rotates relative to the annular magnet 110, teeth and slots 118, 120 pass pole faces 122f, causing pulsations in the magnetic field B, and, consequently, a similarly pulsating EMF in the coil which is registered as a pulsating electrical signal at the electrodes.

Accordingly, it will be understood that the magnetically encapsulated coil package 100 allows for a wider range of axially distributed sizes for the coil than conventional variable reluctance sensors would allow. Further, a variable reluctance sensor equipped with the magnetically encapsulated coil package according to the present invention is generally immune to lap gap variation, allowing it to operate suitably over a wider range of tolerances than possible with a conventional variable reluctance sensor.

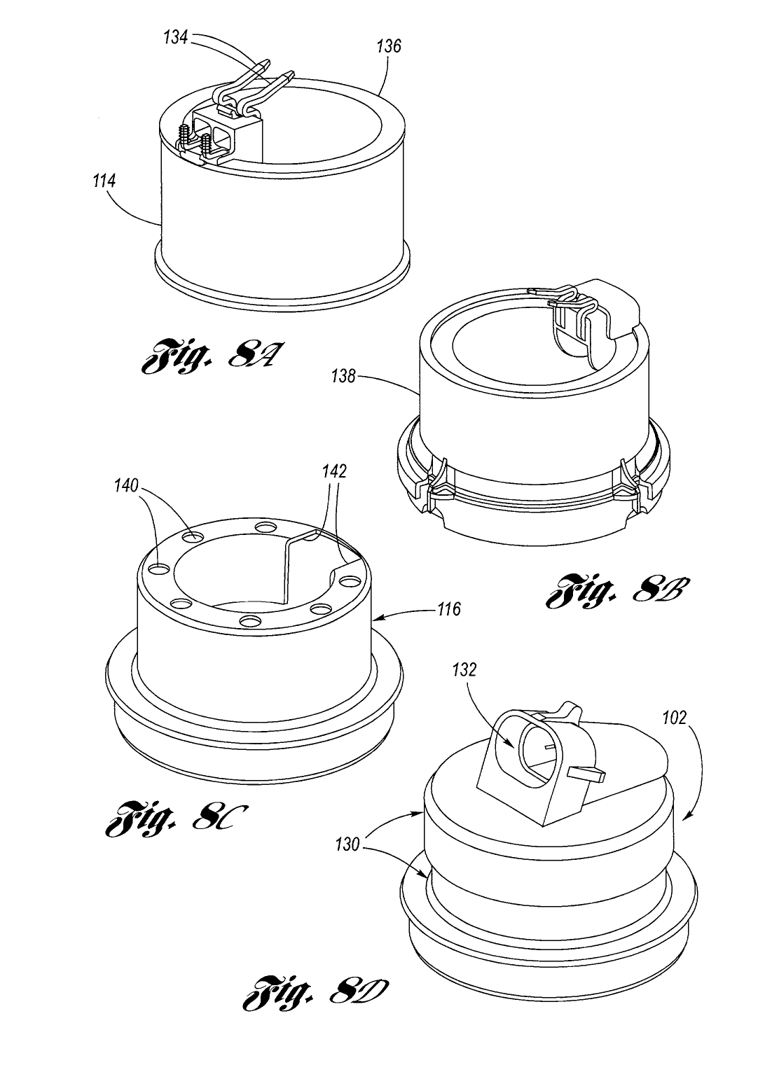

FIGS. 8A through 8D depict steps in assembly of a variable reluctance sensor 102 having a magnetically encapsulated coil package according to the present invention. At FIG. 8A the coil 114 is wound on a spool 136 and the electrodes 134 are connected with the coil. Next, at FIG. 8B, the coil is covered by a plastic covering 138 for processing reasons. The magnetic capsule 116, shown at FIG. 8C, is mounted to the coil. In this regard, the magnetic capsule may have a plurality of anchor holes 140 at the connector component 128 for purposes of anchoring thereto the second housing element 130b. Further in this regard, the magnetic capsule has a cut-out 142 at the connector component 128 and the inboard component 126 to accommodate receiving the electrodes 134 and their associated mounting. Final assembly of the variable reluctance sensor 102 is shown at FIG. 8D.

To those skilled in the art to which this invention appertains, the above described preferred embodiment may be subject to change or modification. Such change or modification can be carried out without departing from the scope of the invention, which is intended to be limited only by the scope of the appended claims.

1. A variable reluctance sensor comprising:
an annular magnet having a plurality of serially alternating dipoles;
a toothed wheel having a plurality of serially arranged teeth and slots, wherein said teeth and slots are located adjacent said di-poles, and wherein said toothed wheel is rotatable in relation to said annular magnet; and
a magnetically encapsulated coil package comprising:
an annular coil disposed substantially adjacent said annular magnet and said toothed wheel; and
a magnetic capsule composed of a magnetically conductive material, said magnetic capsule generally encapsulating said coil between said annular magnet and said toothed wheel.

2. The variable reluctance sensor of claim 1, wherein said magnetic capsule is annular, having a substantially U-shaped cross-section, wherein a first end thereof is located adjacent said annular magnet and wherein a second end thereof is located adjacent said toothed wheel.

3. The variable reluctance sensor of claim 2, wherein said annular coil has an axially elongated configuration with respect to said annular magnet.

4. The variable reluctance sensor of claim 2, wherein said magnetic capsule comprises an outboard component having said first end; an inboard component concentric to said outboard component and having said second end; and a connector component integrally connecting said outbard and inboard components distally with respect to said annular magnet.

5. The variable reluctance sensor of claim 4, wherein said annular coil has an axially elongated configuration with respect to said annular magnet.
